(19) United States
(12) Patent Application Publication
(10) Pub. No.: US 2023/0073775 A1
(43) Pub. Date: Mar. 9, 2023

(54) IMAGE PROCESSING AND MACHINE LEARNING-BASED EXTRACTION METHOD

(71) Applicants: Nathalie Goldstein, San Jose, CA (US); Joachim Niederreiter, Vienna (AT); DeGuang Sea, Maria Lanzendorf (AT); Markus Finster, Vienna (AT)

(72) Inventors: Nathalie Goldstein, San Jose, CA (US); Joachim Niederreiter, Vienna (AT); DeGuang Sea, Maria Lanzendorf (AT); Markus Finster, Vienna (AT)

(21) Appl. No.: 17/467,394

(22) Filed: Sep. 6, 2021

(51) Int. Cl. G06K 9/46; G06K 9/00; G06K 9/32; G06F 16/58; G06N 20/00

(52) U.S. Cl. CPC G06K 9/4609; G06K 9/00463; G06K 9/3208; G06F 16/58; G06N 20/00; G06K 2209/01

(57) ABSTRACT

A system for file image processing and extraction of content from images is provided. The system comprises a computer and an application. When executed on the computer, the application receives a source document containing areas of interest and normalizes the document to align with a stored template image. The application also applies metadata associated with the template image to the areas of interest to identify data fields in the normalized document and extracts data from the identified data fields. The application also processes the extracted data using at least character recognition systems and produces a static structure using at least the identified data fields, the fields containing the processed data. The areas of interest comprise portions of the source document containing text needed to create and populate fields suggested by the stored template image. Normalizing the source document comprises at least one of flipping, rotating, expanding, and shrinking the document.

### CROSS-REFERENCE TO RELATED APPLICATIONS

The present US non-provisional patent application is related to U.S. Provisional Application 63/124,635 filed Dec. 11, 2020, the contents of which are incorporate herein in their entirety.

### FEDERALLY SPONSORED RESEARCH

None.

### SEQUENCE LISTING

None.

### FIELD OF THE INVENTION

The present disclosure is in the field of file image processing and extraction of content from images. More particularly, the present disclosure uses machine image processing algorithms in combination with machine learning techniques that promote semantically accurate data extraction from image-based files.

### BACKGROUND

Large organizations maintain accounting systems and electronic records documenting their activities including transactions with external parties. For each type of record, certain data fields are mandatory or commonplace. For received purchase orders in a simple example, electronic records typically contain customer name, product identification and quantity ordered, and shipping address. When a selling or vending organization's own purchase order is used, the organization's systems can extract directly from a received purchase order as the location and designation of fields and other coding are already known by the organization's own systems.

The systems know what each field in the received purchase order is for. It can easily extract data from the received purchase order, conduct any auditing, and rapidly populate fields in its own storage. The same is true when an industry-standard or other widely accepted document structure is used. The system can easily recognize fields, extract data, and populate fields.

A large organization will often provide a template to require or suggest that customers use in transactions with the organization. A customer may use the template to construct its own document formats for use in transactions with the organization. The customer may add some of its own coding and formatting while still conforming to the requirements of the template.

Inducing a customer to use a document format with fields and structure that comply or at least partially align with the organization's template may facilitate a better account relationship and volume of commerce by simplifying and speeding transactions as well as reducing errors and the need for human intervention.

A large organization may deal with many thousands of vendors, customers, and other parties, some of them not large entities. Such parties may use their own documents in transactions and may not have the resources or incentives to change their documents to conform to a template the large organization may provide.

Documents that outside parties may submit to an organization in a transaction may contain graphics with text that the organization's system cannot recognize. The text may be in unusual fonts or text sizes. Fields may have names that the organization cannot process. The customer's document may contain coding, text, terminology, colors, images, and patterns that the organization's system may not recognize.

The organization, if it values the customer's business or other commercial relationship, may be forced to manually examine the document and enter the data into fields of an appropriate record in its own system. This can be a costly task that still does not guaranty proper execution based at least on the need for human involvement and the potential for error.

In addition, the received document from the customer may arrive in an upside down or backwards state such that it is turned on its side or appears in a flipped or mirror image manner. Even if the text is clear and otherwise acceptable, because of the document's orientation as received, it cannot be read by machine or human.

Previous implementations for handling static structured documents as input images have provided several approaches:

Traditional OCR with information of the text region to extract

Full Artificial Intelligence based

Traditional optical character recognition (OCR) approaches are sensitive regarding input image quality. OCR approaches may be particularly sensitive to positioning constraints OCR has against absolute position of the information subject to extraction.

Artificial intelligence-based solutions have typically struggled to recognize semantics associated with extracted information. Semantics may be position of text in statically structured documents.

There may be at least two prominent challenges associated with extracting information from images. First is the quality of the input image where a multitude of parameters may be optimizable to ensure the success of an extraction phase. Parameters to optimize may range from optical enhancements like adjusting brightness, color manipulation, and spectrum filters to positioning optimizations such as rotation, scaling and skewing.

A second challenge, which is tightly coupled with the extraction phase, is not only to extract the information in text form via OCR but also to recognize the semantic associated with it.

The prior art contains various implementations to meet some of the challenges described above. Several such implementations are described below.

U.S. Pat. No. 10,366,309 (2018) to Becker, Kandpal, Kothari, Porcina, and Malynin focuses on improving optical character recognition (OCR) results through the usage of a second image.

U.S. Pat. No. 10,115,010 (2018) to Becker, Knoblauch, Malynin, and Eappen focuses on identifying a form document in an image using a digital fingerprint of the form document using polygon structures.

U.S. Pat. No. 10,354,134 (2017) to Becker and Coulombe focuses on identifying features in a digital image by dissecting the image and performing the spatial analysis on each individual one.

U.S. Pat. No. 10,417,489 (2016) to Carroll focuses on identifying features in a digital image through the method of aligning an image of a table of a form with an image of a table of a template of the form.

U.S. Pat. No. 8,908,970 (2014) to Blose and Stubler presents a data extraction method for extracting textual information from a document containing text characters using a digital image capture device.

### SUMMARY

Systems and methods are provided herein to normalize and enhance an input image of a document with a static structure for further semantic text extraction. This may be based on a template image and associated and may use machine learning. None of the previous implementations described above or other implementations found provide data extraction methods that combine image processing and machine learning and optimize each step in a workflow. The present disclosure teaches that simple text extraction is not enough, and that context of the information is necessary for the semantic.

### BRIEF DESCRIPTION OF THE FIGURES

FIG. 1 is a block diagram of components and interactions of a system of image processing and machine learning-based extraction in accordance with an embodiment of the present disclosure.

FIG. 2 is a process flow diagram of image processing and machine learning-based extraction in accordance with an embodiment of the present disclosure.

FIG. 3 is a process flow diagram of image processing and machine learning-based extraction in accordance with an embodiment of the present disclosure.

### DETAILED DESCRIPTION

Systems and method described herein provide for addressing the problems described above regarding handling a document with unrecognizable elements or content that may otherwise be difficult to decipher. An application provided herein may be activated when an unfamiliar and at least partially unrecognizable document is received in a transaction or other interaction. The document may be unacceptable for any of the reasons described above. The document may not conform adequately to a template such that contents of the document comprising at least fields and contained data cannot be properly extracted. As noted, the document may contain graphics, images, and non-text content that obscures text or otherwise renders the document unreadable.

When a document of such unknown format and content is received, the application first determines if the document contains items of interest. Such items may comprise specific word, numbers, symbols, or other indicia or markings suggesting the document was sent as part of a transaction or other official communication.

If the document does in fact contain areas of interest, the system may then normalize the document which consists of aligning the document to make it readable. Such normalization may comprise at least one of flipping, rotating, expanding, and shrinking the document. After normalization, processing and extraction steps take place as described below.

Techniques and processes for enhancing and normalize images of documents with a known structure and therefore known semantic (static structured documents) are provided herein. Systems and methods extract information out of an image using artificial intelligence (optical character recognition, OCR), a template image and meta data associated to the template image.

The present disclosure provides for extraction of material from image-based files, for example jpeg and pdf formatted files, and including files that are uploaded into a software application. An intention is to recognize material in the file, extract relevant information, and store the data for future use. By uniquely combining imaging methods, contextual information and OCR, the disadvantages of previous implementations may be mitigated.

Systems and methods are provided for optimizing image quality in regard to positional constraints. An extraction phase may therefore yield better results. The process described herein may be grouped into three phases: Normalization, Processing and Extraction.

For inputs, systems and methods require images to be in electronically processable formats. Examples of such formats comprise bmp, bpm, pgm, ppm, sr, ras, jpeg, jpg, jpe, jp2, tiff, tif and png.

The provisioning of an input image is dependent on the development of the software but can contain:

The transmission over a physical or logical network and supplementation to an API.

Stored on a persistent storage which is directly or indirectly accessible by the software.

Stored locally on a persistent storage which is directly or indirectly accessible by the software.

Another prerequisite for systems and methods provided herein to execute the normalization phase is to supply a template image. The template image acts as a reference image to normalize the input image against which is done in multiple steps. A purpose of the steps in this phase is to enhance the image for follow-up phases. Steps can be executed sequentially or in parallel where it is semantically possible.

Steps may be independently scaled to each other. Main steps provided herein are positional correction steps for correcting rotation, scaling and skewing. The aforementioned steps are leveraging template images in combination of feature detection algorithms (e.g.: SIFT, SURF, ORB), a scoring function and an evaluation function to normalize the input image to the template image.

The execution of a step may be explained as follows:

Executing the feature detection function with the input image of the step and the template image to find features present in both images. A user may take the top nth detected matching features and conduct a search on each set of combination of the features. A matching feature consists of coordinates of a point in the input image and coordinates of a point in the template image. A combination comprises of a pair of features.

Each combination is associated with a provided scoring function.

Each combination is evaluated with the provided an evaluation function to find the most suitable combination in the search space.

Follow up phase is the processing phase which has the prerequisite of meta data which capture the semantic of the data to extract that has to be supplied in a machine processable form. The data may comprise positional information of the area where specific information is to be expected and additional information for step internal use.

The processing phase in combination with the supplied metadata and a search function is being used to identify the area of text which will be used as input for the next phase to extract the information by OCR over the target area. This extraction phase is leveraging machine learning by using language agnostic models for recognition.

### Operation

For a structured document to be processed, a base template image is to be provided which in case of fillable forms can be an empty form.

Additionally, areas of interest which contain text to be extracted are to be identified and a metadata file associated with the template is to be accessed or created.

A machine which satisfies the platform constraints of the software needs to be provided. This may depend on the actual implementation of the software.

Dependencies, libraries and additional third-party tools may need to be installed and configured. This may include the trained model of the machine learning algorithm of the language of the data that is to be extracted.

Setup of software that implements systems and methods provided herein.

The usage of a reference image herein finds the same structure of a form in the input image. Such usage may identify a region of interest and therefor implicitly identify image correction parameters which may be a significant issue for OCR.

The present disclosure may not use the reference image to determine polygons or area in the input image but instead may derive image correction parameters such as skewing or rotation as the form structure.

The present disclosure does not spatially analyze the input image or parts of it but instead performs an image-wide feature detection. Also, classification of unclassified features and establishment of a semantic connection to the spatial template is not necessary of a known form structure.

The present disclosure may not rely on forms with optical grid structure and aligning input and template image to derive form structure and semantic from creating a connection. Systems and methods provided herein may be independent of any geometrical structure to be able to identify and create semantic context.

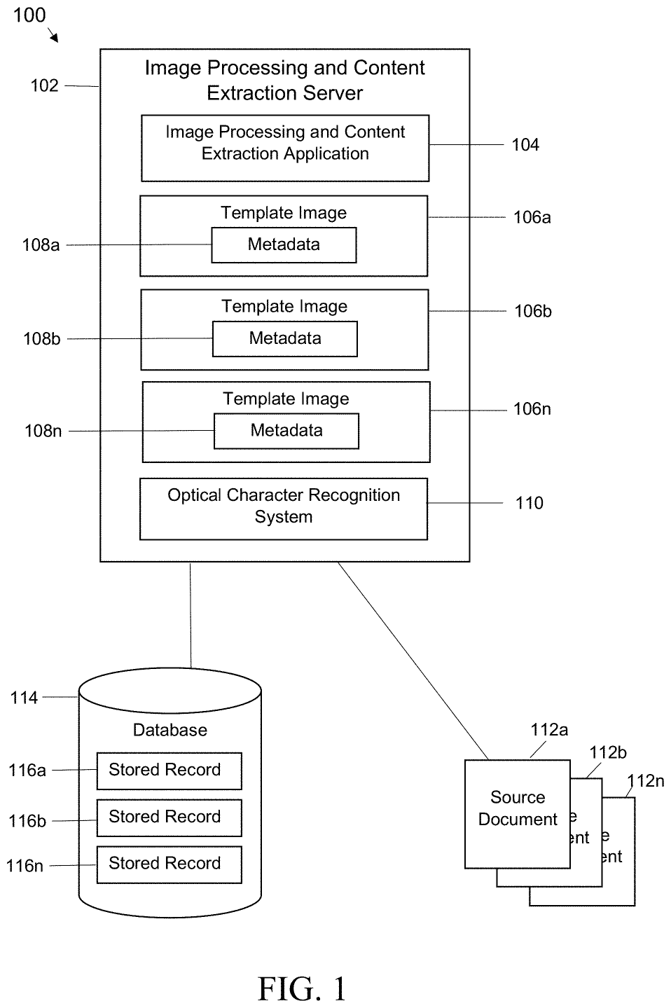

Turning to the figures, FIG. 1 is a block diagram of components and interactions of a system 100 of image processing and machine learning-based extraction in accordance with an embodiment of the present disclosure. The system 100 comprises an image processing and content extraction server 102 and an image processing and content extraction application 104, referred to hereinafter respectively for brevity as the server 102 and the application 104.

The system 100 also comprises template images 106a-n and metadata 108a-n incorporated into each template image 106a-n, respectively, and optical character recognition system 110. While the template images 106a-n, their respective metadata 108a-n and the optical character recognition system 110 are depicted as stored in the server 102, in embodiments these components may be stored elsewhere.

The system 100 also comprises source documents 112a-n, a database 114, and stored records 116a-n. The database 114 is an optional component as the stored records 116a-n may not be database records and may be stored elsewhere.

The server 102 may be more than one physical computer that may be situated at more than one geographic location. The application 104 executes on the server 102 and provides much of the functionality described herein. The application 104 may execute on more than one physical computer.

The source documents 112a-n are documents received for processing that may contain graphics, images, or other content that render these items not possible to process using systems and methods provided by previous implementations. The source documents 112a-n may also be not possible to process as initially received by the server 102 because they were transmitted by the customer or other party in a flipped, mirror image, or rotated state and thus require normalization as described herein.

The stored records 116a-n may be a desired end result of systems and methods provided herein. When the application 104 performs the processed described above of normalization processing, and extraction on a source document 112a and conforms it acceptably to the template 106a such that a static structure may be established, a stored record 116a representing the source document 112a may be created and stored in the database 114 or elsewhere.

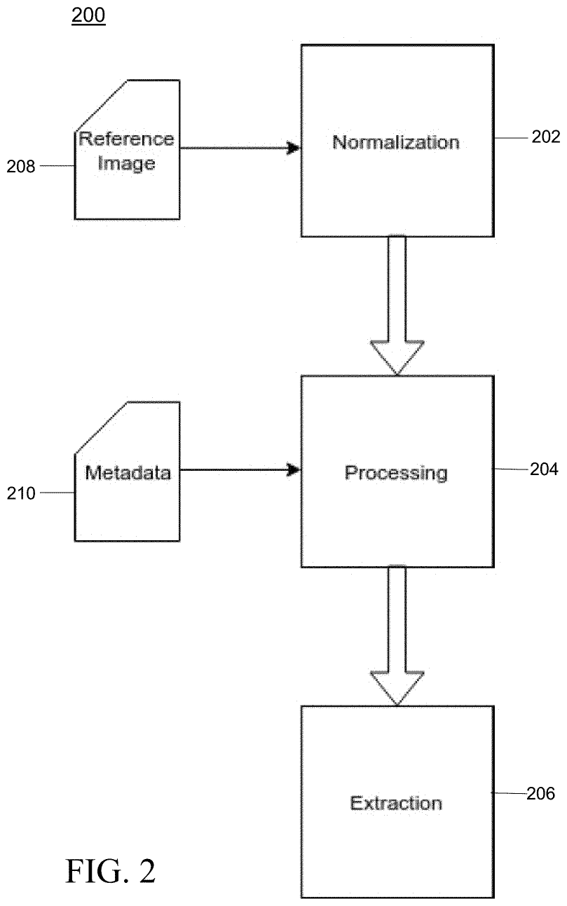

FIG. 2 is a process flow diagram of image processing and machine learning-based extraction in accordance with an embodiment of the present disclosure. FIG. 2 illustrates a process 200 in which normalization 202, processing 204, and extraction 206 take place as described above. A reference image 208 brought into the process of normalization 202 and metadata 210 is brought into the stage of processing 204.

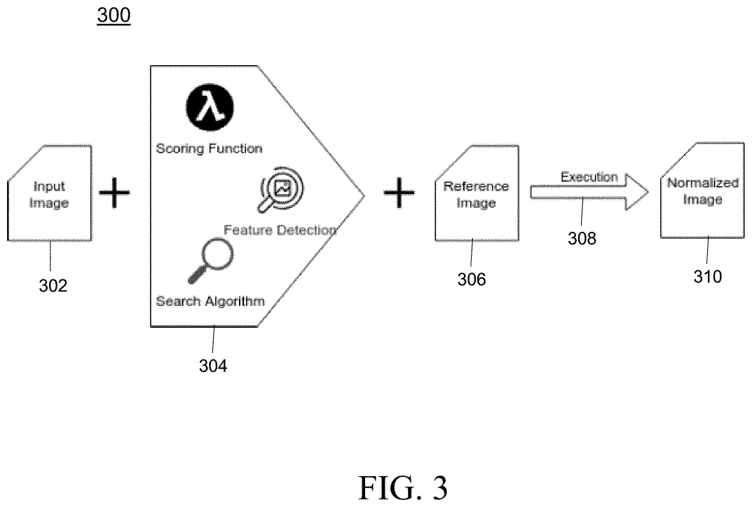

FIG. 3 is a process flow diagram of image processing and machine learning-based extraction in accordance with an embodiment of the present disclosure. FIG. 3 illustrates a process 300 in which an input image 302, which may be analogous to the source document 112a-c provided by the system 100 is subjected to various actions 304. The input image is subjected to a scoring function, feature detection, and at least one search algorithm. The input image 302 and selected results of the actions 304 are combined with a reference image 306 and then subjected to execution 308. A normalized image 310 is a result of the process 300.

In an embodiment, a system for file image processing and extraction of content from images is provided. The system comprises a computer and an application. When executed on the computer, the application receives a source document containing areas of interest and normalizes the document to align with a stored template image. The application also applies metadata associated with the template image to the areas of interest to identify data fields in the normalized document and extracts data from the identified data fields. The application also processes the extracted data using at least character recognition systems and produces a static structure using at least the identified data fields, the fields containing the processed data.

The areas of interest comprise portions of the source document containing text needed to create and populate fields suggested by the stored template image. Normalizing the source document comprises at least one of flipping, rotating, expanding, and shrinking the document. The metadata identifies the data fields at least partially aligning with fields suggested by the template image. The static structure is constructed to align with the template image. The static structure is used to create a stored record based at least partially on the template image. The template image suggests the static structure and mandates at least some data fields needed by the stored record. The source document is image-based and contains graphics, the graphics containing at least some of the data fields. The metadata preserves structure lost during use of character recognition systems.

In another embodiment, a method of adapting material from an unfamiliar document format to a known format is provided. The method comprises a computer determining features in a source document and a template that at least partially match. The method also comprises the computer applying a normalization algorithm to the source document. The method also comprises the computer applying metadata to features in the source document to identify data fields at least similar to data fields in the template. The method also comprises the computer extracting data from the identified fields using at least optical character recognition tools. The method also comprises the computer producing a static structure containing the identified data fields and data within the fields, the structure at least partially matching structure of the template. Normalizing the source document further comprises rotation, scaling, skewing and general positioning correction of the source document. The template is used with the metadata and at least one feature detection algorithm to normalize the source document to an orientation and size of a reference image suggested by the template. The metadata suggests the location of material to be extracted from the source document. The source document is image-based and contains graphics, the graphics containing at least some of the data fields.

In yet another embodiment, a system for file image processing and extraction of content from images is provided. The system comprises a computer and an application executing on the computer that determines that a format of a received document does not conform to a template used for storage of data of a type contained in the received document. The system also normalizes the received document to at least support readability and facilitate identification of fields and data contained within the fields. The system also applies metadata and machine image processing algorithms to identify fields in the source document at least partially matching fields in the template. The system also employs optical character recognition and machine learning techniques that promote semantically accurate data extraction to extract data from the identified fields. The system also builds a static structure based on the identified fields and extracted data to at least partially conform to the template. The metadata identifies fields at least partially aligning with fields suggested by the template image. The received document contains graphics and non-textual content. The static structure is used to create a stored record based at least partially on the template image. The template image suggests the static structure and mandates at least some data fields needed by the stored record. Normalizing the received document comprises at least one of flipping, rotating, expanding, and shrinking the received document.

It will be readily understood that the components, as generally described herein and illustrated in the figures included, may be arranged and designed in different configurations. Therefore, the description herein of the embodiments of systems and methods as represented at least in the included figures, is not intended to limit the scope of the application as claimed but is merely representative of selected embodiments.

What is claimed is:

1. A system for file image processing and extraction of content from images, comprising:
a computer; and
an application executing on the computer that:
receives a source document containing areas of interest,
normalizes the document to align with a stored template image,
applies metadata associated with the template image to the areas of interest to identify data fields in the normalized document,
extracts data from the identified data fields,
processes the extracted data using at least character recognition systems, and
produces a static structure using at least the identified data fields, the fields containing the processed data.

2. The system of claim 1, wherein the areas of interest comprise portions of the source document containing text needed to create and populate fields suggested by the stored template image.

3. The system of claim 1, wherein normalizing the source document comprises at least one of flipping, rotating, expanding, and shrinking the document.

4. The system of claim 1, wherein the metadata identifies the data fields at least partially aligning with fields suggested by the template image.

5. The system of claim 1, wherein the static structure is constructed to align with the template image.

6. The system of claim 1, wherein the static structure is used to create a stored record based at least partially on the template image.

7. The system of claim 1, wherein the template image suggests the static structure and mandates at least some data fields needed by the stored record.

8. The system of claim 1, wherein the source document is image-based and contains graphics, the graphics containing at least some of the data fields.

9. The system of claim 1, wherein the metadata preserves structure lost during use of character recognition systems.

10. A method of adapting material from an unfamiliar document format to a known format, comprising:
a computer determining features in a source document and a template that at least partially match;
the computer applying a normalization algorithm to the source document;
the computer applying metadata to features in the source document to identify data fields at least similar to data fields in the template;
the computer extracting data from the identified fields using at least optical character recognition tools; and
the computer producing a static structure containing the identified data fields and data within the fields, the structure at least partially matching structure of the template.

11. The method of claim 10, wherein normalizing the source document further comprises rotation, scaling, skewing and general positioning correction of the source document.

12. The method of claim 10, wherein the template is used with the metadata and at least one feature detection algorithm to normalize the source document to an orientation and size of a reference image suggested by the template.

13. The method of claim 10, wherein the metadata suggests the location of material to be extracted from the source document.

14. The method of claim 10, wherein the source document is image-based and contains graphics, the graphics containing at least some of the data fields.

15. A system for file image processing and extraction of content from images, comprising:
a computer; and
an application executing on the computer that:
determines that a format of a received document does not conform to a template used for storage of data of a type contained in the received document,
normalizes the received document to at least support readability and facilitate identification of fields and data contained within the fields,
applies metadata and machine image processing algorithms to identify fields in the source document at least partially matching fields in the template,
employs optical character recognition and machine learning techniques that promote semantically accurate data extraction to extract data from the identified fields, and
builds a static structure based on the identified fields and extracted data to at least partially conform to the template.

16. The system of claim 15, wherein the metadata identifies fields at least partially aligning with fields suggested by the template image.

17. The system of claim 15, wherein the received document contains graphics and non-textual content.

18. The system of claim 15, wherein the static structure is used to create a stored record based at least partially on the template image.

19. The system of claim 15, wherein the template image suggests the static structure and mandates at least some data fields needed by the stored record.

20. The system of claim 15, wherein normalizing the received document comprises at least one of flipping, rotating, expanding, and shrinking the received document.
